(19) United States
(12) Patent Application Publication
(10) Pub. No.: US 2024/0103812 A1
(43) Pub. Date: Mar. 28, 2024

(54) INFORMATION PROCESSING APPARATUS, INFORMATION PROCESSING METHOD, AND STORAGE MEDIUM

(71) Applicant: NEC Corporation, Minato-ku, Tokyo (JP)

(72) Inventor: Shinji Ito, Tokyo (JP)

(73) Assignee: NEC Corporation, Minato-ku, Tokyo (JP)

(21) Appl. No.: 18/275,121

(22) PCT Filed: Feb. 3, 2021
(86) PCT No.: PCT/JP2021/003828

§ 371 Date: Jul. 31, 2023

(51) Int. Cl. G06F 7/76

(52) U.S. Cl. CPC G06F 7/76

(57) ABSTRACT

To enable selection of useful vector sequence a₁,a₂, . . . ,a_{T} in a bandit linear optimization algorithm for which a fixed strategy is ineffective, an information processing apparatus (1) includes a vector selection unit (11) that selects a vector aₜ in each round t∈[T] (T is any natural number) from a subset A of a d-dimensional vector space R^{d} (d is any natural number). The vector selection unit (11) uses l₁,l₂, . . . ,l_{T}∈R^{d} as loss vectors to select the vector aₜ in each round t such that an asymptotic behavior of an expected value of tracking regret R(u)=Σ_{t∈[T}]lₜ^{T}aₜ−Σ_{t∈[T}]lₜ^{T}uₜ with respect to any comparative vector sequence u₁,u₂, . . . ,u_{T}∈A or an asymptotic behavior ignoring logarithmic factors of the expected value of the tracking regret R(u) is constrained from above by a preset function A(d,T,P), where P is a natural number not less than 1 given by P=|{t∈[T−1]|uₜ≠uₜ+1}|.

### TECHNICAL FIELD

The present invention relates to an information processing apparatus that solves a bandit linear optimization problem.

### BACKGROUND ART

Use of bandit optimization algorithms is being considered in order to determine advertisements to be presented to a user regarding web advertising and to determine a product to be sold at a discount in web sales. The bandit optimization algorithm refers to an algorithm for selecting a vector representing an action in each round under a bandit feedback condition for the purpose of minimizing a cumulative loss. A bandit optimization algorithm in which a loss in each round is given by a linear function of a selected vector among the bandit optimization algorithms is called a bandit linear optimization algorithm. Examples of a literature that discloses the bandit linear optimization algorithm include Non-patent Literature 1.

### CITATION LIST

### Non-Patent Literature

### Non-Patent Literature 1

Daniely, A., Gonen, A., and Shalev-Shwartz, S., “Strongly adaptive online learning”, In International Conference on Machine Learning, pp. 1405-1411, 2015.

### SUMMARY OF INVENTION

### Technical Problem

In a standard bandit linear optimization algorithm, a vector sequence a₁,a₂, . . . ,a_{T} is selected such that an asymptotic behavior of an expected value of regret RT=Σ_{t∈[T}]lₜ^{T}aₜ−min_{a*∈A}Σ_{t∈[T]}lₜ^{T}a* is constrained from above by T^{1/2}. This causes the following problem. Specifically, for a bandit linear optimization problem for which a fixed strategy to select the same vector in all rounds is effective, a useful vector sequence a₁,a₂, . . . ,a_{T} can be selected. However, for a bandit linear optimization problem for which such a fixed strategy is ineffective, the useful vector sequence a₁,a₂, . . . ,a_{T} cannot be selected.

An example aspect of the present invention has been made in view of the above problem, and an example object thereof is to realize an information processing apparatus that makes it possible to select a useful vector sequence a₁,a₂, . . . ,a_{T} also for a bandit linear optimization problem for which a fixed strategy is not effective.

### Solution to Problem

An information processing apparatus in accordance with an aspect of the present invention includes: a vector selection means that selects a vector aₜ in each round t∈[T] (T is any natural number) from a subset A of a d-dimensional vector space R^{d} (d is any natural number), the vector selection means using l₁,l₂, . . . ,l_{T}∈R^{d} as loss vectors to select the vector aₜ in each round t such that an asymptotic behavior of an expected value of tracking regret R(u)=Σ_{t∈[T}]lₜ^{T}aₜ−Σ_{t∈[T}]lₜ^{T}uₜ with respect to any comparative vector sequence u₁,u₂, . . . ,u_{T}∈A or an asymptotic behavior ignoring logarithmic factors of the expected value of the tracking regret R(u) is constrained from above by a preset function A(d,T,P), where P is a natural number not less than 1 given by P=|{t∈[T−1]|uₜ≠uₜ+1}|.

### Advantageous Effects of Invention

An example aspect of the present invention makes it possible to realize an information processing apparatus that makes it possible to select a useful vector sequence a₁,a₂, . . . ,a_{T} also for a bandit linear optimization problem for which a fixed strategy is not effective.

### BRIEF DESCRIPTION OF DRAWINGS

FIG. 1 is a block diagram illustrating a configuration of an information processing apparatus in accordance with a first example embodiment.

FIG. 2 is a flow diagram showing a flow of an information processing method in accordance with the first example embodiment.

FIG. 3 is a flow diagram showing a first specific example of the information processing method shown in FIG. 2.

FIG. 4 is a flow diagram showing a second specific example of the information processing method shown in FIG. 2.

FIG. 5 is a block diagram illustrating a configuration of a computer functioning as the information processing apparatus in accordance with the first example embodiment.

### DESCRIPTION OF EMBODIMENTS

One example embodiment of the present invention will be described in detail with reference to the drawings.

### Bandit Linear Optimization Problem

Considered are (i) a subset A of a d-dimensional vector space R^{d} and (ii) a loss vector lₜ∈R^{d} defined for each round t∈[T]. Note here that d and T each represent any natural number. [T] represents a set of natural numbers not less than 1 and not more than T.

Among problems of selecting a vector sequence a₁,a₂, . . . ,a_{T}∈A, the problem of targeting minimization of a cumulative loss Σ_{t∈[T}]lₜ^{T}aₜ is referred to as an “online linear optimization problem”. In the present example embodiment, the online linear optimization problem is considered under the following bandit feedback condition.

Bandit feedback condition: After selecting the vector aₜ in the round t, it is (1) possible to refer to a value of a loss lₜ^{T}aₜ with respect to the selected vector aₜ and (2) impossible to refer to a loss lₜ^{T}a_{t′} with respect to a vector a_{t′} that is different from the selected vector aₜ.

The online optimization problem under the above-described bandit feedback condition is referred to as a “bandit linear optimization problem”, and an algorithm for solving a bandit linear optimization problem is referred to as a “bandit linear optimization algorithm”.

In the following, a tracking regret R(u) defined for any comparative vector sequence u₁,u₂, . . . ,u_{T}∈A is used as an evaluation index of the bandit linear optimization algorithm. The tracking regret R(u) is an evaluation index devised by the inventors of the present invention. The tracking regret R(u) is defined by a difference between a cumulative loss Σ_{t∈[T]}lₜ^{T}aₜ of the vector sequence a₁,a₂, . . . ,a_{T} selected by the bandit linear optimization algorithm and a cumulative loss Σ_{t∈[T}]lₜ^{T}uₜ of any comparative vector sequence. The use of the tracking regret R(u) as the evaluation index makes it possible to find a vector sequence a₁,a₂, . . . ,a_{T} that sufficiently reduces the cumulative loss Σ_{t∈[T}]lₜ^{T}aₜ also for the bandit linear optimization problem for which a fixed strategy is not effective.

### Configuration of Information Processing Apparatus

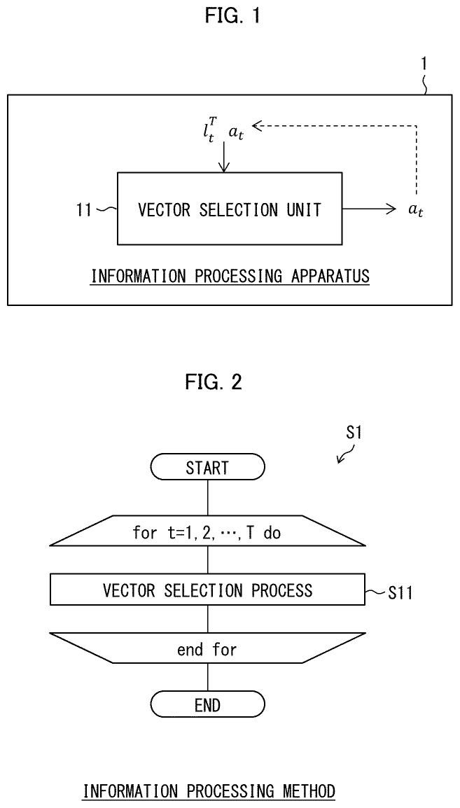

A configuration of an information processing apparatus 1 in accordance with the present example embodiment will be described with reference to FIG. 1. FIG. 1 is a block diagram illustrating a configuration of the information processing apparatus 1.

The information processing apparatus 1 is an apparatus for solving the bandit linear optimization problem for a subset A of a d-dimensional vector space R^{d}. As illustrated in FIG. 1, the information processing apparatus 1 includes a vector selection unit 11.

The vector selection unit 11 is a means for selecting the vector aₜ in each round t. The vector selection unit 11 selects the vector aₜ in each round t such that an asymptotic behavior of an expected value of tracking regret R(u)=Σ_{t∈[T}]lₜ^{T}aₜ−Σ_{t∈[T}]lₜ^{T}uₜ with respect to any comparative vector sequence u₁,u₂, . . . ,u_{T}∈A or an asymptotic behavior ignoring logarithmic factors of the expected value of the tracking regret R(u) is constrained from above by a preset function A(d,T,P). Note, here, that P is a natural number not less than 1 given by P=|{t∈[T−1]|uₜ≠uₜ+1}|. When the vector selection unit 11 has selected the vector aₜ in the round t, a loss lₜ^{T}aₜ corresponding to the vector aₜ is fed back to the vector selection unit 11.

Note that the vector selection unit 11 is an example of a “vector selection means” in the claims. The vector aₜ that is selected by the vector selection unit 11 may be provided to a user via a display or the like, or may be provided to another apparatus via a communication network or the like. The vector a t that is selected by the vector selection unit 11 may be used in various processes carried out inside the information processing apparatus 1.

Hereinafter, constraining the asymptotic behavior of the tracking regret R(u) from above by a function A(d,T,P) is also referred to as R(u)=O(A(d,T,P)). Note, here, that O is O of Landau. Further, constraining the asymptotic behavior ignoring the logarithmic factors of the tracking regret R(u) from above by the function A(d,T,P) is also referred to as R(u)=˜O(A(d,T,P)). Note, here, that ˜O(“˜” denoted above “O” in the mathematical formula is denoted herein on the left of “O”) is O of Landau ignoring logarithmic factors.

### Flow of Information Processing Method

A flow of an information processing method S1 in accordance with the present example embodiment will be described with reference to FIG. 2. FIG. 2 is a flow diagram showing the flow of the information processing method S1.

The information processing method S1 is a method for solving a bandit linear optimization problem for a subset A of a d-dimensional vector space R^{d}. The information processing method S1 includes a vector selection process S11 as shown in FIG. 2.

The vector selection process S11 is a process for selecting a vector aₜ∈A in each round t∈[T]. In the vector selection process S11, the vector aₜ is selected in each round t such that an asymptotic behavior of an expected value of tracking regret R(u)=Σ_{t∈[T}]lₜ^{T}aₜ−Σ_{t∈[T}]lₜ^{T}uₜ with respect to any comparative vector sequence u₁,u₂, . . . ,u_{T}∈A or an asymptotic behavior ignoring logarithmic factors of the expected value of the tracking regret R(u) is constrained from above by a preset function A(d,T,P). The vector selection process S11 is carried out by, for example, the vector selection unit 11 of the information processing apparatus 1.

### Effect of Information Processing Apparatus and Information Processing Method

In a standard bandit linear optimization algorithm, the vector sequence a₁,a₂, . . . ,a_{T} is selected such that an asymptotic behavior of an expected value of regret RT=Σ_{t∈[T}]lₜ^{T}aₜ−min_{a*∈A}Σ_{t∈[T}]lₜ^{T}a* is constrained from above by T^{1/2}. Therefore, for a bandit linear optimization problem for which a fixed strategy to select the same vector in all rounds is effective, a useful vector sequence a₁,a₂, . . . ,a_{T} can be selected. However, for a bandit linear optimization problem for which such a fixed strategy is ineffective, the useful vector sequence a₁,a₂, . . . ,a_{T} cannot be selected.

In contrast, in the information processing apparatus 1 and the information processing method S1 in accordance with the present example embodiment, the vector sequence a₁,a₂, . . . ,a_{T} is selected such that an asymptotic behavior of an expected value of tracking regret R(u)=Σ_{t∈[T}]lₜ^{T}aₜ−Σ_{t∈[T}]lₜ^{T}uₜ or an asymptotic behavior ignoring logarithmic factors of the expected value of the tracking regret R(u) is constrained from above by a preset function A(d,T,P). In this case, the comparative vector sequence u₁,u₂, . . . ,u_{T} need not be constant.

It is therefore possible to select the useful vector sequence a₁,a₂, . . . ,a_{T} also for the bandit linear optimization problem for which the fixed strategy is not effective.

### First Specific Example of Information Processing Method

The inventors of the present invention have succeeded in proving, regarding the bandit linear optimization problem, the following theorem A.

Theorem A: If a vector sequence a₁,a₂, . . . ,a_{T} is a vector sequence selected by an algorithm shown in Table 1 below, the following expression (a0) holds true for any comparative vector sequence u₁,u₂, . . . ,u_{T}∈A,

$$E [ R ( u ) ] = 0 ( γ T + Cd \sqrt{\frac{T ( 1 + P )}{γ}} ( {d}^{1 / 4} + \sqrt{log T} ) ) \qquad ( a0 )$$

where E[⋅] represents an expected value for internal randomness of the algorithm.

This causes an asymptotic behavior ignoring the logarithmic factors of the expected value of the regret R(u) to be constrained from above by A(d,T,P) given by the expression (a1):

$$A ( d , T , P ) = {d}^{5 / 6} {T}^{2 / 3} \cdot ( β + \sqrt{\frac{1 + P}{β}} ) \qquad ( a1 )$$

where β is a constant not less than 1.

For a particular P, by setting β to β=Θ((1+P)^{1/3}), the asymptotic behavior ignoring the logarithmic factors of the expected value of regret R(u) is constrained from above by A(d,T,P) given by the equation (a2)

A(d, T, P)=d^{5/6}(1+P)^{1/3}T^{2/3} (a2)

```
TABLE 1
Algorithm 1 FTPL-based algorithm for online linear optimization
with bandit feedback
Require: Action set [symbol]  , time horizon T ∈ [symbol]  , exploration
  ratio γ ∈ (0, 1), exploration basis π, rounds segments
  {[sⱼ, eⱼ]}_{j∈N}, learning rates {ηⱼ}_{j∈N}, perturbation factors {ρⱼ}_{j∈N}.
```

| | |
|---|---|
| 1: | For j ∈ Active(1), set w₁^{(j)} = ηⱼ. Compute M = S(π)^{-1/2}. |
| 2: | for t = 1, 2, . . . , T do |
| 3: | for j ∈ Active(t) do |
| 4: | Pick rₜ^{(j)} from a d dimensional standard normal |
| | distribution. |
| 5: | Set aₜ^{(j)} by |
| | ${a}_{t}^{( j )} ∈ {argmin}_{r ∈ A} \{ {( {\sum }_{τ = {s}_{j}}^{t - 1} {\hat{ℓ}}_{τ} - {ρ}_{j} {Mr}_{t}^{( j )} )}^{⊤} x \} . \qquad ( 19 )$ |
| 6: | $Set {q}_{t}^{( j )} by {q}_{t}^{( j )} = \frac{{w}_{i}^{( j )}}{{\sum }_{{j}^{′} ∈ Active ( t )} {w}_{t}^{( j ′ )}} .$ |
| 7: | end for |
| 8: | Pick jₜ following the probability distribution |
| | qₜ, i.e., set jₜ so that Prob[jₜ = j] = qₜ^{(j)} for j ∈ Active(t). |
| 9: | With probability γ, set explore = Yes, other- |
| | wise explore = No. |
| 10: | if explore == Yes then |
| 11: | Choose aₜ following the probability distribution π |
| | and output aₜ. |
| 12: | $Get feedback of {ℓ}_{t}^{⊤} {a}_{t} and set {\hat{ℓ}}_{t} = \frac{{ℓ}_{t}^{⊤} {a}_{t}}{γ} {( S ( π ) )}^{- 1} {α}_{t} .$ |
| 13: | Compute |
| | ${r}_{t} = {\sum }_{j ∈ Active ( t )} {\hat{ℓ}}_{t}^{⊤} {a}_{i}^{( j )} {q}_{i}^{( j )} . \qquad ( 20 )$ |
| 14: | For j ∈ Active(t) ∩ Active{t + 1}, set wₛ₊₁^{(j)} by |
| | wₜ₊₁^{(j)} = wₜ^{{j}}(1 + ηⱼ (rₜ − [symbol] ᵢ^{T}aₜ^{(j)})). (21) |
| 15: | For j ∈ Active(t + 1) \ Active(t), set wₜ₊₁^{(j)} = ηⱼ. |
| 16: | else |
| 17: | Output aₜ^{(j}^{ₜ}⁾. |
| 18: | set [symbol] ₜ = 0 and wᵢ₊₁ = wₜ. |
| 19: | end if |
| 20: | end for |

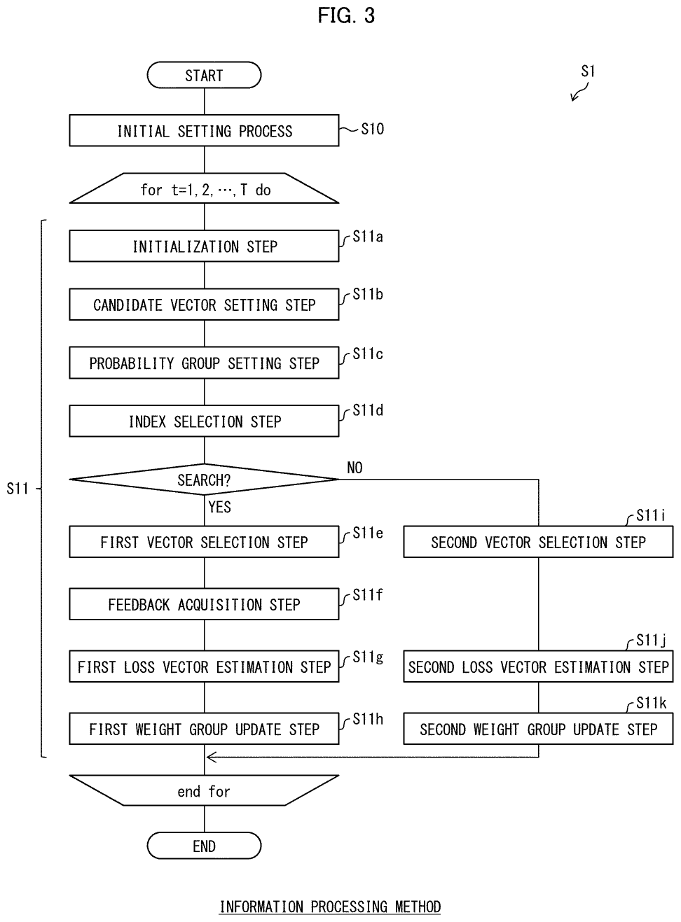

The following description will discuss, with reference to FIG. 3, a specific example of the information processing method S1 which specific example is obtained by embodying the above theorem. The above theorem merely provides an example of the present example embodiment. The present example embodiment should not be construed as being limited to the theorem.

FIG. 3 is a flow diagram showing a flow of the information processing method S1 in accordance with a specific example of the present invention.

In the information processing method S1 in accordance with a specific example of the present invention, the initial setting process S10 is carried out in advance of the vector selection process S11. In the initial setting process S10, an exploration ratio γ∈(0,1), an exploration basis π, a round segment sequence {[sⱼ,eⱼ]}_{j∈N}, a learning rate sequence {ηⱼ}_{j∈N}, and a perturbation factor sequence {ρⱼ}_{j∈N} are set.

Note, here, that the exploration ratio γ is a real number greater than 0 and less than 1. The exploration ratio γ is set to, for example, a value specified by the user. The exploration basis π is a probability distribution on a subset A. For example, the exploration basis π is set such that g(π) defined by g(π)=max_{b∈A}bS(π)⁻¹b using S(π)=Σ_{a∈A}π(a)aa^{T} satisfies g(π)≤Cd (C is a constant not less than 1). A round segment [sⱼ,eⱼ] is a set of successive rounds defined by The round segment sequence {[sⱼ,eⱼ]}_{j∈N} is set in accordance with, for example, the expression (a3) below. A learning rate ηⱼ is a real number. The learning rate ηⱼ is set in accordance with the expression (a4) below using, for example, the round segment sequence {[sⱼ,eⱼ]}_{j∈N}. A perturbation factor ρⱼ is a real number. The perturbation factor ρⱼ is set in accordance with the expression (a5) below using, for example, the round segment sequence {[sⱼ,eⱼ]}_{j∈N}.

$${U}_{k ∈ ℕ} \{ [ i \cdot {2}^{k - 1} , ( i + 1 ) \cdot {2}^{k - 1} - 1 ] \vert i ∈ ℕ \} = \{ [ {s}_{ik} , {e}_{ik} ] \vert k ∈ ℕ , i ∈ ℕ \} = {\{ [ {s}_{j} , {e}_{j} ] \}}_{j ∈ ℕ} \qquad ( a3 )$$

$${η}_{j} = ⊖ ( \frac{1}{Cd} min \{ \sqrt{\frac{γ log T}{{e}_{j} - {s}_{j} + 1}} , γ \} ) \qquad ( a4 )$$

$${ρ}_{j} = ⊖ ( \sqrt{\frac{( {e}_{j} - {s}_{j} + 1 ) C}{γ}} {d}^{\frac{1}{4}} ) \qquad ( a5 )$$

The vector selection process S11 includes an initialization step S11a, a candidate vector setting step S11b, a probability group setting step S11c, a selection index specification step S11d, a first vector selection step S11e, a feedback acquisition step S11f, a first loss vector estimation step S11g, a first weight group update step S11h, a second vector selection step S11i, a second loss vector estimation step S11j, and a second weight group update step.

The initialization step S11a is a step of setting the weight w₁^{(j)} to w₁^{(j)=η}ⱼ and setting the matrix M to M=S(π)^{-1/2} for each j∈Active (t).

The candidate vector setting step S11b is a step of setting a candidate vector group {aₜ^{(j)}}_{j∈Active(t)} according to loss vectors \hat{ }₁,\hat{ }₂, . . . ,\hat{ }ₜ₋₁ estimated in and before the previous round t−1. In the specific example of the present invention, the d-dimensional standardized normal distribution rₜ^{(j)} is used to set the candidate vector aₜ(i) for each j∈Active(t) in accordance with the following expression (a6).

$${a}_{t}^{( j )} ∈ {arg min}_{x ∈ A} \{ {( {\sum }_{τ = {s}_{j}}^{t - 1} {\hat{l}}_{τ} + {τ}_{j} {Mr}_{t}^{( j )} )}^{T} x \} \qquad ( a6 )$$

The probability group setting step S11c is a step of setting a probability group qₜ={qₜ^{(j)}}_{j∈Active(t)} according to a weight group wₜ={wₜ^{(j)}}_{j∈Active(t)} updated in the previous round t−1. In the specific example of the present invention, a probability qₜ^{(j)} is set for each j∈Active(t) in accordance with the following expression (a7).

$${q}_{t}^{( j )} = \frac{{w}_{t}^{( j )}}{{\sum }_{j ′ ∈ Active ( t )} {w}_{t}^{( {j}^{′} )}} \qquad ( a7 )$$

The index selection step S11d is a step of randomly selecting an index jₜ in accordance with a probability group qₜ. In the specific example of the present invention, the index jₜ satisfying Prob[jₜ=j]=qₜ^{(j)} is selected for any j∈Active(t).

The vector selection unit 11 carries out either exploratory vector selection or non-exploratory vector selection. The probability that the vector selection unit 11 carries out the exploratory vector selection is γ, and the probability that the vector selection unit 11 carries out the non-exploratory vector selection is 1−γ.

The exploratory vector selection is composed of a first vector selection step S11e, a feedback acquisition step S11f, a first loss vector estimation step S11g, and a first weight group update step S11f.

The first vector selection step S11e is a step of randomly selecting the vector aₜ from the candidate vector group {aₜ^{(j)}}_{j∈Active(t)} in accordance with a preset exploration basis π.

The feedback acquisition step S11f is a step of acquiring a feedback lₜ^{T}aₜ according to the vector aₜ.

The first loss vector estimation step S11g is a step of estimating a loss vector \hat{ }lₜ (“\hat{ }” denoted above “1” in the mathematical formula is denoted herein in front of “1”) according to the feedback lₜ^{T}aₜ. In the specific example of the present invention, it is estimated that the loss vector \hat{ }lₜ is \hat{ }lₜ=lₜ^{T}aₜ/γ)(S(π))⁻¹aₜ.

The first weight group update step S11f is a step of updating the weight group wₜ according to the loss vector \hat{ }lₜ. In the specific example of the present invention, the weight group wₜ is updated in accordance with the following expression (a8).
For j∈Active(t)∩Active(t+1), set wₜ₊₁^{(j)} by wₜ₊₁^{(j)}=(rₜ−\hat{l}ₜ^{r}aₜ^{(j)}))
For j∈Active(t)\Active(t), set wₜ₊₁^{(j)} by wₜ₊₁^{(j)}=ηⱼ

In the specific example of the present invention, the rₜ is calculated in accordance with the following expression (a9).

$${r}_{t} = {\sum }_{j ∈ Active ( t )} {\hat{l}}_{t}^{T} {a}_{t}^{( j )} {q}_{t}^{( j )} \qquad ( a9 )$$

The non-exploratory vector selection is composed of a second vector selection step S11i, a second loss vector estimation step S11j, and a second weight group update step S11k.

The second vector selection step S11i is a step of selecting a vector aₜ^{(jt)} from the candidate vector group {aₜ^{(j)}}_{j∈Active(t)}. An index ^{jt} is an index randomly selected from Active(t) in accordance with a probability group qₜ. Thus, the vector aₜ^{(jt)} can be regarded as a vector which is randomly selected in accordance with the probability group qt from the candidate vector group {aₜ^{(j)}}_{j∈Active(t)}.

The second loss vector estimation step S11j is a step of estimating the loss vector \hat{ }lₜ as \hat{ }lₜ=0.

The second weight group update step S11k is a step of updating the weight group wₜ in accordance with wₜ₊₁=wₜ.

Second Specific Example of Information Processing Method

The inventors of the present invention have succeeded in proving, regarding the bandit linear optimization problem, the following theorem B.

Theorem B: If a vector sequence a₁,a₂, . . . ,a_{T} is a vector sequence selected by an algorithm shown in Table 2 below, the following expression (b0) holds true for any comparative vector sequence a₁,a₂, . . . ,a_{T}∈A,

$$E [ R ( u ) ] = 0 ( γ T + η dT + \frac{1}{η} ( ( 1 + P ) ( d log T + log \frac{1}{α} ) + T α ) ) \qquad ( b0 )$$

where E[⋅] represents an expected value for internal randomness of the algorithm.

This causes an asymptotic behavior of the expected value of the regret R(u) to be constrained from above by A(d,T,P) given by the expression (b1),

$$A ( d , T , P ) = d \sqrt{T log T} \cdot ( β + \frac{1 + P}{β} ) \qquad ( b1 )$$

where β is a constant not less than 1.

For a particular P, by setting β to β=θ((1+P)^{1/2}), the asymptotic behavior of the expected value of regret R(u) is constrained from above by A(d,T,P) given by the expression (b2).

A(d, T, P)=d\sqrt{(1+P)T logT} (b2)

```
TABLE 2
Algorithm 2 MWU-based algorithm for online linear optimization
with bandit feedback
Require: Convex action set [symbol]  , time horizon T ∈ [symbol]  ,
  exploration ratio γ ∈ (0, 1), sbare ratio α ∈ (0, 1),
  exploration basis π, learning rate η > 0
```

| | |
|---|---|
| 1: | Initialize wₜ: [symbol] → [symbol] by w₁(x) = 1 for all x ∈ [symbol] . |
| 2: | Set W₁ by |
| | W₁ = ∫_{x∈} [symbol] w₁(x)dx = ∫_{x∈} [symbol] dx. (22) |
| 3: | for t = 1, 2, . . . , T do |
| 4: | Pick an action aₜ according to the distribution |
| | ${p}_{t} = ( 1 - γ ) \cdot \frac{{w}_{t}}{{W}_{t}} + γ \cdot π . \qquad ( 23 )$ |
| 5: | Get feedback of [symbol] ₜ^{T} aₜ and compute [symbol] ₜ given by |
| | [symbol] ₜ = [symbol] ₜ^{T}aₜ · (S(pₜ))⁻¹aₜ. (24) |
| 6: | Update wₜ and Wₜ by |
| | vₜ₊₁(x) = wₜ(x) exp(−η [symbol] ₜ^{T}x), (25) |
| | Wₜ₊₁ = [symbol] vₜ₊₁(x)dx, (26) |
| 7: | end for |

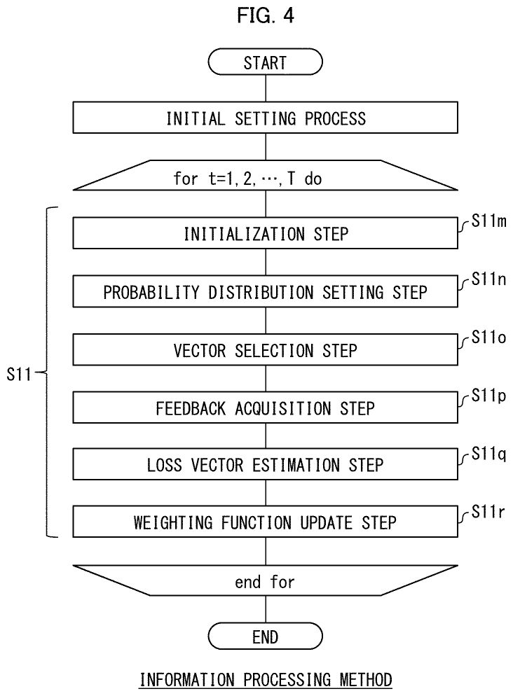

The following description will discuss, with reference to FIG. 4, a specific example of the information processing method S1 which specific example is obtained by embodying the above theorem. The above theorem merely provides an example of the present example embodiment. The present example embodiment should not be construed as being limited to the theorem.

FIG. 4 is a flow diagram showing a flow of the information processing method S1 in accordance with a specific example of the present invention.

In the information processing method S1 in accordance with a specific example of the present invention, the initial setting process S10 is carried out in advance of the vector selection process S11. In the initial setting process S10, an exploration ratio γ∈(0,1), a sharing ratio α∈(0,1), an exploration basis π, and a learning rate η>0 are set.

Note, here, that the exploration ratio γ is a real number greater than 0 and less than 1. The exploration ratio γ is set to, for example, a value specified by the user. The sharing ratio α is a real number greater than 0 and less than 1. The sharing ratio α is set to, for example, α=Θ(1/T). The exploration basis π is a probability distribution on a subset A. For example, the exploration basis π is set such that g(π) defined by g(π)=max_{b∈A}bS(π)⁻¹b using S(π)=Σ_{a∈A}π(a)aa^{t} satisfies g(π)≤Cd (C is a constant not less than 1). A learning rate raj is a positive real number. The learning rate η is set to, for example, η=γ/(2Cd), where γ is Θ(dβ(ClogT/T)^{1/2}).

The vector selection process S11 includes an initialization step S11m, a probability distribution setting step S11n, a vector selection step S11o, a feedback acquisition step S11p, a loss vector estimation step S11q, and a weighting function update step S11r.

In the initialization step S11a, a weighting function w₁(t): A→R is set to an identity function w₁(x)=1, and a weight W1 is set in accordance with the following expression (b3).

W₁=∫_{x∈A}w₁(x)dx=∫_{x∈A}dx (b3)

The probability distribution setting step S11m is a step of setting a probability distribution pₜ: A→[0,1] according to the weighting function wₜ: A→R updated in the previous round t−1. In a specific example of the present invention, the probability distribution pₜ is set in accordance with the following expression (b4).

$${p}_{t} = ( 1 - γ ) \cdot \frac{{w}_{t}}{{w}_{t}} + γ \cdot π \qquad ( b4 )$$

The vector selection step S11o is a step of randomly selecting the vector aₜ from the subset A in accordance with the probability distribution pₜ.

The feedback acquisition step S11p is a step of acquiring a feedback lₜ^{T}aₜ according to the vector aₜ.

The loss vector estimation step S11q is a step of estimating a loss vector \hat{ }lₜ according to the feedback. In the specific example of the present invention, it is estimated that the loss vector \hat{ }lₜ is \hat{ }lₜ=lₜ^{T}aₜ (S(pₜ))⁻¹aₜ.

The weighting function update step S 1 lr is a step of updating the weighting function wₜ according to the loss vector \hat{ }lₜ . In the specific example of the present invention, the weighting function wₜ is updated in accordance with the following expressions (b5), (b6), and (b7).

$${v}_{t + 1} ( x ) = {w}_{t} ( x ) exp ( - η {\hat{l}}_{t}^{T} x ) \qquad ( b5 )$$

$${W}_{t + 1} = {\int }_{x ∈ A} {v}_{t + 1} ( x ) dx \qquad ( b6 )$$

$${w}_{t + 1} ( x ) = ( 1 - α ) \cdot {v}_{t + 1} ( x ) + α \frac{{W}_{t + 1}}{{W}_{1}} \qquad ( b7 )$$

### Software Implementation Example

Some or all of functions of the information processing apparatus 1 can be realized by hardware provided in an integrated circuit (IC chip) or the like or can be alternatively realized by software. In the latter case, the functions of the units of the information processing apparatus 1 are realized by, for example, a computer that executes instructions of a program that is software.

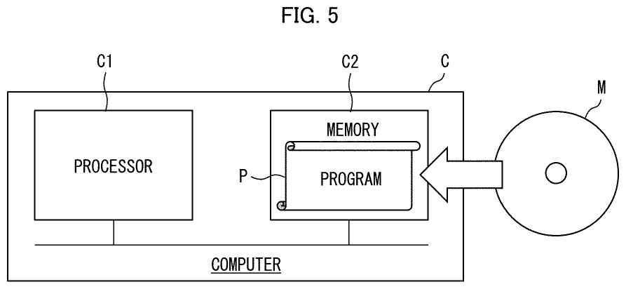

FIG. 5 illustrates an example of such a computer (hereinafter referred to as a “computer C”). As illustrated in

FIG. 5, the computer C includes at least one processor C1 and at least one memory C2. The at least one memory C2 stores a program P for causing the computer C to operate as the information processing apparatus 1. In the computer C, the at least one processor C1 reads and executes the program P stored in the at least one memory C2, so that the functions of the units of the information processing apparatus 1 are realized.

Examples of the at least one processor C1encompass a central processing unit (CPU), a graphic processing unit (GPU), a digital signal processor (DSP), a micro processing unit (MPU), a floating point number processing unit (FPU), a physics processing unit (PPU), a microcontroller, and a combination thereof. Examples of the at least one memory C2 encompass a flash memory, a hard disk drive (HDD), a solid state drive (SSD), and a combination thereof.

Note that the computer C may further include a random access memory (RAM) in which the program P is to be loaded while being executed and in which various kinds of data are to be temporarily stored. The computer C may further include a communication interface through which data is to be transmitted and received between the computer C and at least one other apparatus. The computer C may further include an input/output interface through which (i) an input apparatus(s) such as a keyboard and/or a mouse and/or (ii) an output apparatus(s) such as a display and/or a printer is/are to be connected to the computer C.

The program P can be recorded in a non-transitory, tangible storage medium M capable of being read by the computer C. Examples of such a storage medium M encompass a tape, a disk, a card, a semiconductor memory, and a programmable logic circuit. The computer C can acquire the program P via the storage medium M. The program P can alternatively be transmitted via a transmission medium. Examples of such a transmission medium encompass a communication network and a broadcast wave. The computer C can alternatively acquire the program P via the transmission medium.

### Application Examples

The information processing apparatus 1 described earlier is applicable to various problems. An example of this is shown below.

### Provision of Discount Coupons

The following description will consider the problem of determining a discount coupon to be provided to a customer by an operating company of a certain electronic commerce site. In this case, the action of determining the discount coupon to be provided to a plurality of customers is expressed by a vector a t components of which are the types of the discount coupons to be provided to the customers. For example, an action of providing a discount coupon of a product 1 to a customer A, providing a discount coupon of a product 2 to a customer B, and providing a discount coupon of a product 3 to a customer C is expressed by a vector aₜ =(1,2,3, . . . ). Then, it is assumed that a loss lₜ^{T}aₜ is obtained as a feedback. Here, the loss ltTat may be a value based on whether the discount coupon is used, a gaze time, whether the discount coupon has been clicked, a purchase price of a product, a purchase probability, a purchase price, and the like. In this case, application of the above-described information processing method S1 makes it possible to determine a discount coupon that reduces a loss. In particular, even in a case where customer's preferences and utilities tend to change, such as online marketing, it is possible to provide an optimal discount coupon for each customer.

### (Delivery and Transportation)

The following description will consider the problem of determining a delivery route or a transportation route (hereinafter referred to as “route”) by an agent of, for example, a delivery truck that delivers packages or a delivery taxi that is to be allocated and that provides transportation of customers. In this case, an action of determining the route is expressed by a vector aₜ having, as components, the presence or absence of selection for each of a plurality of routes. For example, an action of determining a route passing through a first path, not passing through a second path, and passing through a third path is expressed by a vector aₜ=(1,0,1, . . . ). Then, it is assumed that a loss lₜ^{T}aₜ (for example, a delivery cost) is obtained as a feedback.

In this case, application of the above-described information processing method S1 makes it possible to determine a route that reduces a loss. In particular, it is possible to optimize a delivery plan that is susceptible to environments such as weather conditions and congestion conditions.

### (Retail)

The following description will consider the problem of determining the rates of increase/discount on beer prices of individual companies in a certain store. In this case, an action of determining the rates of increase/discount on the beer prices of the individual companies is expressed by a vector aₜ having, as components, the rates of increase/discount on the beer prices of the individual companies. For example, an action of setting a beer price of a company A to a fixed price, setting a 20% increase in a beer price of a company B from a fixed price, and setting a 10% reduction in a beer price of a company C from a fixed price is expressed by a vector aₜ=(0,+2,−1, . . . ). Then, it is assumed that a loss lₜ^{T}aₜ is obtained as a feedback. In this case, application of the above-described information processing method S1 makes it possible to determine rates of increase/discount that reduce a loss.

### Investment Portfolio

The following description will consider the problem of determining an investment action of an investor. In this case, an action of investment (purchase, capital increase) with respect to a plurality of financial products (stock brands, etc.) held or to be held by the investor, or selling or holding of the plurality of financial products is expressed by a vector aₜ having, as components, details of the investment action with respect to the financial products. For example, an action of an additional investment in stocks of a company A, holding (neither purchasing nor selling) receivables of a company B, and selling stocks of a company C is expressed by a vector aₜ=(1,0,2, . . . ). Then, it is assumed that a loss lₜ^{T}aₜ is obtained as a feedback. In this case, application of the above-described information processing method S1 makes it possible to determine an investment action that reduces a loss.

### (Clinical Trial)

The following description will consider the problem of determining an administration action for a clinical trial of a certain drug of a pharmaceutical company. In this case, an action of determining doses of administration to a plurality of subjects and the presence or absence of administration thereto is expressed by a vector aₜ having, as components, details of the administration action with respect to each of the subjects. For example, an action of carrying out administration in a dose 1 to a subject A, not carrying out administration with respect to a subject B, and carrying out administration in a dose 2 with respect to a subject C is expressed by a vector aₜ=(1,0,2, . . . ).

Then, it is assumed that a loss lₜ^{T}aₜ (for example, side effect occurrence rate) is obtained as a feedback. In this case, application of the above-described information processing method S1 makes it possible to determine an administration action that reduces a loss.

### Additional Remark 1

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### Additional Remark 2

The whole or part of the example embodiments disclosed above can be described as, but not limited to, the following supplementary notes.

### (Supplementary Note 1)

An information processing apparatus including:
a vector selection means that selects a vector aₜ in each round t∈[T] (T is any natural number) from a subset A of a d-dimensional vector space R^{d} (d is any natural number),
the vector selection means using l₁,l₂, . . . ,l_{T}∈R^{d} as loss vectors to select the vector aₜ in each round t such that an asymptotic behavior of an expected value of tracking regret R(u)=Σ_{t∈[T}]lₜ^{T}aₜ--EterriltTut with respect to any comparative vector sequence u₁,u₂, . . . ,u_{T}∈A or an asymptotic behavior ignoring logarithmic factors of the expected value of the tracking regret R(u) is constrained from above by a preset function A(d,T,P),
where P is a natural number not less than 1 given by P=|{t∈[T−1]|uₜ≠Uₜ+1}|.

### (Supplementary Note 2)

The information processing apparatus according to Supplementary note 1, wherein
the vector selection means selects a vector sequence a₁,a₂, . . . ,a_{T}∈A such that the asymptotic behavior ignoring the logarithmic factors of the expected value of the tracking regret R(u) is constrained from above by the function A(d,T,P), and
the function A(d,T,P) is given by the following expression (al) for unspecified P or is given by the following expression (a2) for specified P,

$$A ( d , T , P ) = {d}^{5 / 6} {T}^{2 / 3} \cdot ( β + \sqrt{\frac{1 + P}{β}} ) \qquad ( a1 )$$

where β is a constant not less than 1,

A(d,T,P)=d^{5/6}(1+p)^{1/3}T^{2/3} (a2)

### (Supplementary Note 3)

The information processing apparatus according to Supplementary note 2, wherein
in each round t, the vector selection means carries out:
a candidate vector setting step of setting a candidate vector group {aₜ^{(j)}}_{j∈Active(t)} according to loss vectors \hat{ }l₂₁, \hat{ }l₂, . . . , \hat{ }lₜ₋₁ estimated in and before a previous round t−1;
a probability group setting step of setting a probability group qₜ={qₜ^{(j)}}_{j∈Active(t)} according to a weight group wₜ={wₜ^{(j)}}_{j∈Active(t)} updated in the previous round t−1; and
either (1) a first vector selection step of randomly selecting the vector aₜ from the candidate vector group {aₜ^{(j)}}_{j∈Active(t)} in accordance with a preset exploration basis π, a first loss vector estimation step of estimating a loss vector \hat{ }lₜ in accordance with a feedback, and a first weight group update step of updating a weight group wₜ in accordance with the loss vector \hat{ }lₜ or (2) a second vector selection step of randomly selecting the vector aₜ from the candidate vector group {aₜ^{(j)}}_{j∈Active(t)} in accordance with the probability group qₜ, a second loss vector estimation step of estimating the loss vector \hat{ }lₜ as \hat{ }lₜ=0, and a second weight group update step of updating wₜ in accordance with wₜ₊₁=wₜ.

### (Supplementary Note 4)

The information processing apparatus according to Supplementary note 1, wherein
the vector selection means selects a vector sequence a₁,a₂, . . . ,a_{T}∈A such that the asymptotic behavior of the expected value of the tracking regret R(u) is constrained from above by the function A(d,T,P), and
the function A(d,T,P) is given by the following expression (b 1) for unspecified P or is given by the following expression (b2) for specified P,

$$A ( d , T , P ) = d \sqrt{T log T} \cdot ( β + \frac{1 + P}{β} ) \qquad ( b1 )$$

where β is a constant not less than 1,

A(d,T,P)=d{square root over ((1+P)(T log T)} (b2)

### (Supplementary Note 5)

The information processing apparatus according to Supplementary note 4, wherein
in each round t, the vector selection means carries out:
a probability distribution setting step of setting a probability distribution pₜ: A→[0,1] according to a weighting function wₜ: A→R updated in the previous round t−1;
a vector selection step of randomly selecting the vector aₜ from a subset A in accordance with the probability distribution pₜ;
a loss vector estimation step of estimating a loss vector \hat{ }lₜ in accordance with a feedback; and
a weighting function update step of updating the weighting function wₜ according to the loss vector \hat{ }lₜ.

### (Supplementary Note 6)

An information processing apparatus including:
a vector selection means that selects a vector aₜ in each round t∈[T] (T is any natural number) from a subset A of a d-dimensional vector space R^{d} (d is any natural number), wherein
in each round t, the vector selection means carries out:
a candidate vector setting step of setting a candidate vector group {aₜ^{(j)}}_{j∈Active(t)} according to loss vectors \hat{ }l₁, \hat{ }l₂, . . . , \hat{ }lₜ₋₁ estimated in and before a previous round t-1;
a probability group setting step of setting a probability group qₜ={qₜ^{(j)}}_{j∈Active(t)} according to a weight group wₜ={wₜ^{(j)}}_{j∈Active(t)} updated in the previous round t−1; and either (1) a first vector selection step of randomly selecting the vector aₜ from the candidate vector group {aₜ^{(j)}}_{j∈Active(t)} in accordance with a preset exploration basis π, a first loss vector estimation step of estimating a loss vector \hat{ }lₜ in accordance with a feedback, and a first weight group update step of updating a weight group wₜ in accordance with the loss vector \hat{ }lₜ or (2) a second vector selection step of randomly selecting the vector aₜ from the candidate vector group {aₜ^{(j)}}_{j∈Active(t)} in accordance with the probability group qₜ, a second loss vector estimation step of estimating the loss vector

\hat{ }lₜ as \hat{ }lₜ=0, and a second weight group update step of updating wₜ in accordance with wₜ₊₁=wₜ.

### (Supplementary Note 7)

An information processing apparatus including:
a vector selection means that selects a vector aₜ in each round t∈[T] (T is any natural number) from a subset A of a d-dimensional vector space R^{d} (d is any natural number), wherein
in each round t, the vector selection means carries out:
a probability distribution setting step of setting a probability distribution pₜ: A→[0,1] according to a weighting function wₜ: A→R;
a vector selection step of randomly selecting the vector aₜ from a subset A in accordance with the probability distribution pₜ;
a loss vector estimation step of estimating a loss vector \hat{ }lₜ in accordance with a feedback; and
a weighting function update step of updating the weighting function wₜ according to the loss vector \hat{ }lₜ.

### (Supplementary Note 8)

An information processing method including:
selecting a vector aₜ in each round t∈[T] (T is any natural number) from a subset A of a d-dimensional vector space R^{d} (d is any natural number),
in the selection of the vector aₜ, using l₁,l₂, . . . ,l_{T}∈R^{d} as loss vectors to select the vector aₜ in each round t such that an asymptotic behavior of an expected value of tracking regret R(u)=Σ_{t∈[T}]lₜ^{T}aₜ−Σ_{t∈[T}]lₜ^{T}uₜ with respect to any comparative vector sequence u₁,u₂, . . . ,u_{T}∈A or an asymptotic behavior ignoring logarithmic factors of the expected value of the tracking regret R(u) is constrained from above by a preset function A(d,T,P),
where P is a natural number not less than 1 given by P=|{t∈[T−1]|uₜ≠uₜ+1}|.

### (Supplementary Note 9)

A program for causing a computer to operate as an information processing apparatus,
the program causing the computer to function as:
a vector selection means that selects a vector aₜ in each round t∈[T] (T is any natural number) from a subset A of a d-dimensional vector space R^{d} (d is any natural number),
the vector selection means using l₁,l₂, . . . ,l_{T}∈R^{d} as loss vectors to select the vector aₜ in each round t such that an asymptotic behavior of an expected value of tracking regret R(u)=Σ_{t∈[T}]lₜ^{T}aₜ−Σ_{t∈[T}]lₜ^{T}uₜ with respect to any comparative vector sequence u₁,u₂, . . . ,u_{T}∈A or an asymptotic behavior ignoring logarithmic factors of the expected value of the tracking regret R(u) is constrained from above by a preset function A(d,T,P),

where P is a natural number not less than 1 given by P=|{t∈[T−1]|uₜ≠uₜ+1}|.

### (Supplementary Note 10)

A computer-readable storage medium storing the program according to Supplementary note 9.

### (Supplementary Note 11)

An information processing apparatus including at least one processor, the at least one processor carrying out:
a vector selection process of selecting a vector aₜ in each round t∈[T] (T is any natural number) from a subset A of a d-dimensional vector space R^{d} (d is any natural number),
the vector selection process using l₁,l₂, . . . ,l_{T}∈R^{d} as loss vectors to select the vector aₜ in each round t such that an asymptotic behavior of an expected value of tracking regret R(u)=Σ_{t∈[T}]lₜ^{T}aₜ−Σ_{t∈[T}]lₜ^{T}uₜ with respect to any comparative vector sequence u₁,u₂, . . . ,u_{T}∈A or an asymptotic behavior ignoring logarithmic factors of the expected value of the tracking regret R(u) is constrained from above by a preset function A(d,T,P),
where P is a natural number not less than 1 given by P=|{t∈[T−1] |uₜ≠uₜ+1}|.

### (Supplementary Note 12)

Note that any of these information processing apparatuses may further include a memory, which may store a program for causing the at least one processor to carry out the vector selection process. Note also that the program may be recorded in a non-transitory, tangible computer-readable storage medium.

### REFERENCE SIGNS LIST

1 information processing apparatus
11 vector selection unit (vector selection means)
51 information processing method
511 vector selection process

What is claimed is:

1. An information processing apparatus comprising:
at least one processor, the at least one processor carrying out:
a vector selection process of selecting a vector aₜ in each round t∈[T] (T is any natural number) from a subset A of a d-dimensional vector space R^{d} (d is any natural number),
in the vector selection process, the at least one processor using I₁, I₂, . . . ,I_{T}∈R^{d} as loss vectors to select the vector aₜ in each round t such that an asymptotic behavior of an expected value of tracking regret R(u)=Σ_{t∈[T}]lₜ^{T}aₜ−Σ_{t∈[T}]lₜ^{T}uₜ with respect to any comparative vector sequence u1,u2, . . . ,u_{T}∈A or an asymptotic behavior ignoring logarithmic factors of the expected value of the tracking regret R(u) is constrained from above by a preset function A(d,T,P),
where P is a natural number not less than 1 given by P=|{t∈[T−1]|uₜ≠uₜ+1}|.

2. The information processing apparatus according to claim 1, wherein
in the vector selection process, the at least one processor selects a vector sequence a₁,a₂, . . . ,u₁,u₂, . . . ,u_{T}∈A _{T}∈A such that the asymptotic behavior ignoring the logarithmic factors of the expected value of the tracking regret R(u) is constrained from above by the function A(d,T,P), and
the function A(d,T,P) is given by the following expression (a1) for unspecified P or is given by the following expression (a2) for specified P,
$$A ( d , T , P ) = {d}^{5 / 6} {T}^{2 / 3} \cdot ( β + \sqrt{\frac{1 + P}{β}} ) \qquad ( a1 )$$
where β is a constant not less than 1,
A(d,T,P)=d^{5/6}(1+p)^{1/3}T^{2/3} (a2)

3. The information processing apparatus according to claim 2, wherein in each round t, the at least one processor, in the vector selection means, process, carries out:
a candidate vector setting process of setting a candidate vector group {aₜ^{(j)}}_{j∈Active(t)} according to loss vectors \hat{ }l₂₁, \hat{ }l₂, . . . , \hat{ }lₜ₋₁ estimated in and before a previous round t−1;
a probability group setting process of setting a probability group qₜ={qₜ^{(j)}}_{j∈Active(t)} according to a weight group wₜ={wₜ^{(j)}}_{j∈Active(t)} updated in the previous round t-1; and
either (1) a first vector selection process of randomly selecting the vector at from the candidate vector group {aₜ^{(j)}}_{j∈Active(t)} in accordance with a preset exploration basis π, a first loss vector estimation process of estimating a loss vector \hat{ }lₜ in accordance with a feedback, and a first weight group update process of updating a weight group wₜ in accordance with the loss vector \hat{ }lₜ or (2) a second vector selection process of randomly selecting the vector aₜ from the candidate vector group {aₜ^{(j)}}_{j∈Active(t)} in accordance with the probability group qₜ, a second loss vector estimation process of estimating the loss vector \hat{ }lₜ as \hat{ }lₜ=0, and a second weight group update process of updating wₜ in accordance with wₜ+i=wₜ.

4. The information processing apparatus according to claim 1, wherein
in the vector selection process, the at least one processor selects a vector sequence a₁,a₂, . . . ,a_{T}∈A such that the asymptotic behavior of the expected value of the tracking regret R(u) is constrained from above by the function A(d,T,P), and
the function A(d,T,P) is given by the following expression (b1) for unspecified P or is given by the following expression (b2) for specified P,
$$A ( d , T , P ) = d \sqrt{T log T} \cdot ( β + \frac{1 + P}{β} ) \qquad ( b1 )$$
where β is a constant not less than 1,
A(d,T,P)=d{square root over ((1+P)(T log T)} (b2)

5. The information processing apparatus according to claim 4, wherein
in each round t, the at least one processor, in the vector selection process, carries out:
a probability distribution setting process of setting a probability distribution pₜ: A→[0,1] according to a weighting function wₜ: A→R updated in the previous round t−1;
a vector selection process of randomly selecting the vector \hat{ }lₜ from a subset A in accordance with the probability distribution pₜ;
a loss vector estimation process of estimating a loss vector \hat{ }lₜ in accordance with a feedback; and
a weighting function update process of updating the weighting function wₜ according to the loss vector \hat{ }lₜ.

6. An information processing apparatus comprising:
at least one processor, the at least one processor carrying out:
a vector selection process of selecting a vector aₜ in each round t∈[T] (T is any natural number) from a subset A of a d-dimensional vector space R^{d} (d is any natural number), wherein
in each round t, the at least one processor, in the vector selection means, process, carries out:
a candidate vector setting process of setting a candidate vector group {aₜ^{(j)}}_{j∈Active(t)} according to loss vectors \hat{ }l₁, \hat{ }l₂, . . . , \hat{ }lₜ₋₁ estimated in and before a previous round t−1,
a probability group setting process of setting a probability group qₜ={qₜ^{(j)}}_{j∈Active(t)} according to a weight group wₜ={wₜ^{(j)}}_{j∈Active(t)} updated in the previous round t−1; and
either (1) a first vector selection process of randomly selecting the vector at from the candidate vector group {aₜ^{(j)}}_{j∈Active(t)} in accordance with a preset exploration basis π, a first loss vector estimation process of estimating a loss vector \hat{ }lₜ in accordance with a feedback, and a first weight group update process of updating a weight group wₜ in accordance with the loss vector \hat{ }lₜ or (2) a second vector selection process of randomly selecting the vector aₜ from the candidate vector group {aₜ^{(j)}}_{j∈Active(t)} in accordance with the probability group qₜ, a second loss vector estimation process of estimating the loss vector \hat{ }lₜ as \hat{ }lₜ=0, and a second weight group update process of updating wₜ in accordance with wₜ+i=wₜ.

7. (canceled)

8. An information processing method comprising:
selecting a vector aₜ in each round t∈[T] (T is any natural number) from a subset A of a d-dimensional vector space R^{d} (d is any natural number),
in the selection of the vector at, using I₁, I₂, . . . ,I_{T}∈R^{d} as loss vectors to select the vector aₜ in each round t such that an asymptotic behavior of an expected value of tracking regret R(u)=Σ_{t∈[T}]lₜ^{T}aₜ−Σ_{t∈[T}]lₜ^{T}uₜ with respect to any comparative vector sequence u₁,u₂, . . . ,u_{T}∈A or an asymptotic behavior ignoring logarithmic factors of the expected value of the tracking regret R(u) is constrained from above by a preset function A(d,T,P),
where P is a natural number not less than 1 given by P=|{t∈[T−1]|uₜ≠uₜ+1}|.

9. A computer-readable non-transitory storage medium storing a program for causing a computer to function as the information processing apparatus according to claim 1, the program causing the computer to carry out the vector selection process.
